(19) United States
(12) Patent Application Publication
(10) Pub. No.: US 2022/0277102 A1
(43) Pub. Date: Sep. 1, 2022

(54) Process using one-way hashing function for secure collection, presentation and storage of PII

(71) Applicant: John JungKyun Kim, Suwanee, GA (US)

(72) Inventor: John JungKyun Kim, Suwanee, GA (US)

(21) Appl. No.: 17/592,745

(22) Filed: Feb. 4, 2022

Related U.S. Application Data
(60) Provisional application No. 63/154,800, filed on Feb. 28, 2021.

(51) Int. Cl. G06F 21/62; H04L 9/06

(52) U.S. Cl. CPC G06F 21/6245; H04L 9/0643

(57) ABSTRACT

The present disclosure describes systems and methods for the secure collection, storage and presentation of sensitive personally identifiable information. The method includes a data transformation process centrally administered by a trusted third-party that utilizes a one-way hash function to transform the personally identifiable information into a hash digest—an unintelligible string of random digits and characters—at the point and time of collection for storage and subsequent reference, essentially replacing sensitive personal data with hash digests as representative tokens of the original information without revealing the true values.

A one-way hash function reliably produces the same hash digest output given the same input. Once captured and stored the hash digest linked to the individual can serve as the functional equivalent of the original personally identifiable information, able to uniquely identify the individual with whom it is associated without revealing the true plaintext values of their personally identifiable information.

### BACKGROUND

A one-way hashing function is a mathematical algorithm whereby input data are transformed into an unintelligible output called a hash digest of a specified length. This one-way operation is irreversible. That is, a hashing operation cannot be calculated in reverse in order to derive the original input value. Further, for a given input, a hashing operation reliably generates the same output.

The core feature of the present disclosure is inspired by the method by which passwords are stored for online authentication of user identity. The authentication process relies upon the data obfuscation feature of one-way hashing and the repeatability of the results. As part of an online account creation process, a prospective user is prompted to choose and enter a password. The password is not saved by the host system, rather it is transformed using a one-way hashing function into an unintelligible string of data called a hash digest. This hash digest is the value that is saved by the host system as the representation of the user's selected password. In subsequent account login attempts, the hashing process is repeated, whereby the password known only to the user is entered and is transformed into a hash digest. The resulting hash digest is compared to the hash digest recorded in the user's account authentication parameters in the host system. If the hash digest generated at login matches the hash digest known to the host system, the user is authenticated and access is granted.

In other embodiments, one-way hashing is used as a means of obfuscating sensitive data for secure storage, a form of “security through obscurity.”

The present disclosure uses a one-way hashing function to replace sensitive personally identifiable information, such as the social security number with the hash digest generated from it in a variety of scenarios where sensitive personal information must be referenced. For example, the social security number is often the primary means to establish identity for financial transactions such as applying for loans, financial accounts, or credit cards. Because it is unique to each individual and assigned to nearly every legal resident in the United States, the social security number has become the most universally adopted identification number for the purpose of record keeping. Due to its ubiquity in databases that contain identifying information of individuals, data breaches often lead to the theft of social security numbers and other private data. When social security numbers are stored in databases as plaintext, they can be readily exploited by criminal actors to commit identity theft and financial fraud.

### SUMMARY

Systems and methods are presented here for alternate means of collecting and storing personally identifiable information and other sensitive data in plaintext for the purpose of identifying individuals and accounts. One-way hashing uses a cryptographic algorithm that transforms an input value into a random hash digest (an unintelligible string of random text) of predetermined length. The process cannot be reversed. The hash digest output cannot be recalculated in reverse to derive the original input. Hash functions can be MD-5, any of SHA-1/SHA-2/SHA-3 families of cryptographic functions or successor hash functions. The embodiment of the present disclosure is not dependent upon employing a specific hash function.

While a hash digest is irreversible, one method of cracking hash values is to create a table of all possible hash values of all potential input values—an inventory of potential values called a rainbow table. For example, the social security number format of nine digits limits the possible permutations of digits to one billion unique combinations. A rainbow table can be created that contains the hash digests of all one billion combinations of nine digits. A hash digest can be compared to the list of digests for all one billion combinations to determine which nine-digit input generated the output. This type of cracking effort can be thwarted by the addition of a “salt”, a secret random value that is prepended or appended to the original input prior to performing the hashing operation. Such a salted input produces a hash digest that is completely different from one generated without the salt. Because of the added randomness, a hash digest generated with a salt makes it infeasible to crack using rainbow tables due to the extensive computing resources and time required to generate the hash digests of the enormous number of possible input values that result from the addition of a random salt.

This disclosure illustrates the embodiment using an example process of collecting a social security number by a Data Collector via an online interface such as a web-form. Such interactions can include but are not limited to establishing financial accounts, applying for employment, enrolling in schools or registering to receive healthcare services. However the system and methods can facilitate any similar interaction where a Data Owner is required to provide any other form of personal information. In the instant example Data Owner may be required to enter their social security number in a specified field of an online application web-form. This data input field is configured to initiate a separate process whereby a secure connection is made to a trusted external third-party administered Data Hash Management System that transforms the entered plaintext data into a random data string called the hash digest using a one-way hash function. The hashing process is repeatable; it reliably generates the same output from a given input every time it is run.

The core data transformation process involves two steps; salting and hashing the plaintext input to generate an initial hash digest, then salting and hashing the initial hash digest to generate a second hash digest which adds additional complexity and layered obscurity. The two step process makes rainbow table attacks magnitudes more difficult, practically infeasible. In the first hashing step a Shared Secret Salt is appended to all Data Owners' input for the initial data transformation that generates Hash Digest 1. The Shared Secret Salt is a randomly generated data string that is stored in a Hardware Security Module or similarly hardened dedicated network security appliance. For added randomness and complexity, each Data Owner's Hash Digest 1 is then assigned a Unique Salt value generated by a program function. Hash Digest 1 and its Unique Salt value are recorded in the Salt Table in a secure database contained within the Data Hash Management System architecture and blocked from external access by means of a firewall configured with strict access rules. The Salt Table is a directory of a Data Owner's Hash Digest 1 and their Unique Salt value to be looked up in order to generate their Hash Digest 2 each time the hashing operation is executed. Safekeeping the Shared Secret Salt and the Unique Salt Table in a Hardware Security Module and in an isolated database, respectively, ensures that the secret salt values remain hidden from unauthorized access and remain highly secure.

Hash Digest 1 with the appended Unique Salt value is hashed again to generate Hash Digest 2. The resulting Hash Digest 2 represents the applicant's secure alternative social security number and is saved to a customer information database in place of their actual plaintext social security number. Each time a social security number is processed through these steps, it reliably generates the same Hash Digest 1 and Hash Digest 2 values. Hash Digest 2 is therefore a perfect substitute for the original plaintext social security number and can be used in its place interchangeably without having to disclose the actual plaintext value.

The core security feature of this embodiment is that by recording the Hash Digest 2 value in place of the plaintext input, the Data Collector never takes possession of the Data Owner's actual social security number, and therefore is not at risk of losing it as a result of a data breach and exfiltration. Data Owners no longer need to entrust their sensitive information to Data Collectors while retaining the ability to verify their identity using what is the functional equivalent substitute value that is immune to compromise by bad actors.

### BRIEF DESCRIPTION OF THE FIGURES

The figures included herein are integral to the present disclosure. Reviewing the figures in conjunction with the foregoing summary and accompanying explanation will help the reader to clearly understand the processes and the benefits that the invention provides.

FIG. 1 is a block diagram depicting a high-level overview of the process flow and interconnection scheme comprising a Data Owner, Data Collector and Data Hash Management System.

FIG. 2 is a block diagram depicting the interactive process flow between the Data Collector's web-form and the Data Hash Management System outlining the steps by which data entered by the Data Owner is transformed into a hash digest and returned to the Data Collector's system.

FIG. 3 is a block diagram depicting the initial transaction process flow that establishes a Data Owner's presence in the Data Hash Management System. This initial interaction establishes a Hash Digest 1 for the Data Owner, generates and assigns a random Unique Salt and records the matched pair in the Salt Table for subsequent lookup to generate Hash Digest 2. The resulting Hash Digest 2 is transmitted back to the Data Collector's web-form and recorded into its database in lieu of the actual plaintext social security number.

FIG. 4 is a block diagram depicting the process flow within the Data Hash Management System where a returning Data Owner's input is transformed into Hash Digest 1, which is looked up in the Salt Table to identify their Unique Salt, then transformed into Hash Digest 2 and transmitted back to the Data Collector to reference in regular business processes.

### DETAILED DESCRIPTION

Key Terms are Defined:

Data Owner—individual person providing their personally identifiable information to an entity in a commercial transaction or other administrative activity.
Data Collector—entity collecting personally identifiable information and maintaining custody of such information in the regular course of its business.
Data Hash Management System—a dedicated and isolated data transformation system and methods hosted on a standalone server with strong authentication process for pre-vetted and approved entities and users. System is configured to have limited interconnectivity to the network through a restricted interface that is controlled by internal firewall access rules.
Hardware Security Module—any dedicated network security appliance used exclusively for the secure storage of highly sensitive information such as passwords, encryption keys or other secrets that is tamper and compromise resistant.
Hash Manager—third party intermediary administrator of the Data Hash Management System.
Hash Function—any of currently published MD-5, SHA-1, SHA-2 or SHA-3 hashing functions or any successor versions.
Hash Digest 1—the transformed output of the first of two hashing steps. Used as the identifier in a directory of Data Owners and their Unique Salt values without reliance on their plaintext identifiers.
Shared Secret Salt—randomly generated string of data of predetermined length that is prepended or appended to all plaintext input in the initial transformation step that generates Hash Digest 1.
Hash Digest 2—the second and final transformed output retained by the Data Collector in place of the plaintext personally identifiable information of a Data Owner.
Unique Salt—randomly generated unique string of data of predetermined length that is assigned to each Hash Digest 1 and prepended or appended thereto to generate Hash Digest 2.
Salt Table—lookup table of Hash Digest 1 and assigned Unique Salt values within the Data Hash Management System.

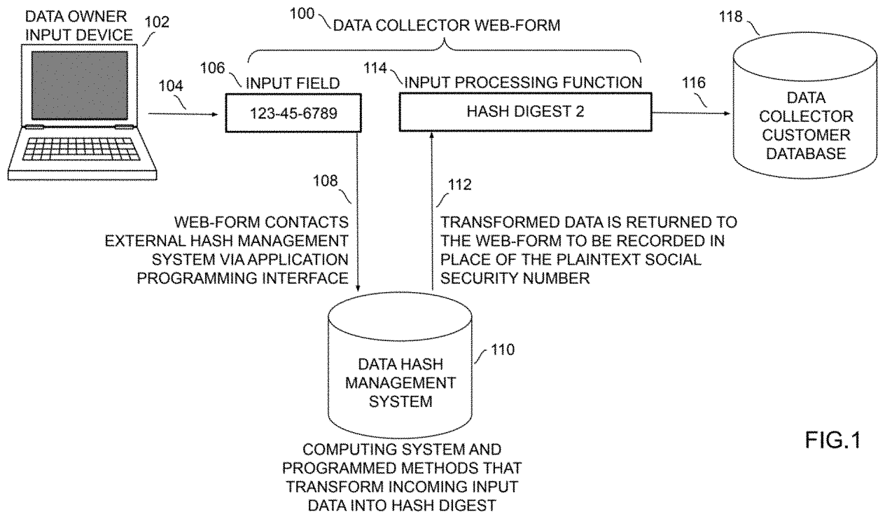

FIG. 1 shows a simplified block diagram of the Data Collector's public facing internet data collection web-form 100 receiving a social security number entered by a Data Owner 102. A Data Collector can be any entity that collects information about customers and users. This embodiment is exemplified by a bank collecting information including the social security number from an applicant wishing to open an account. The Data Owner can be any individual who in the course of registering to use a service submits identifying information such as their social security number to a Data Collector.

Data Owner's input device can be any computing device with a keyboard or other user input interface, a tablet with touch screen, or a smartphone. The Data Owner connects to the Data Collector's website via an internet connection 104 using the secure HTTPS protocol. Data Owner enters their social security number into the provided input field in the Data Collector's web-form 106. Input is also possible in-person using a keypad connected to the Data Collector's computer system.

The data transformation process runs on the Data Hash Management System 110 that is managed by a trusted third party administrator (Hash Manager). The Data Collector's web-form initiates an Application Programming Interface (“API”) connection over a secure encrypted data transmission tunnel 108 such as a VPN to the Data Hash Management System 110. The plaintext input is transformed into a hash digest by the programmed processes of the Data Hash Management System and transmitted back over encrypted data transmission tunnel 112 to the Input Processing Function 114 whereby the transformed hash value is saved to the Data Collector Customer Database instead of the Data Owner's plaintext social security number.

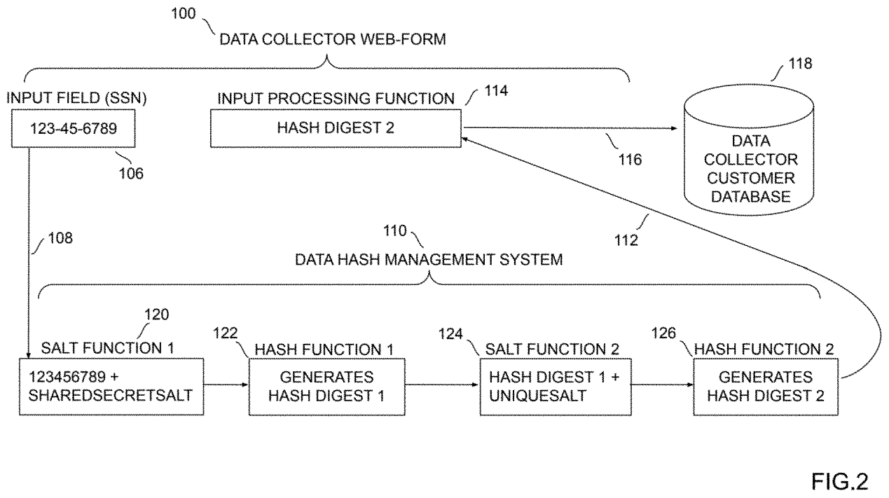

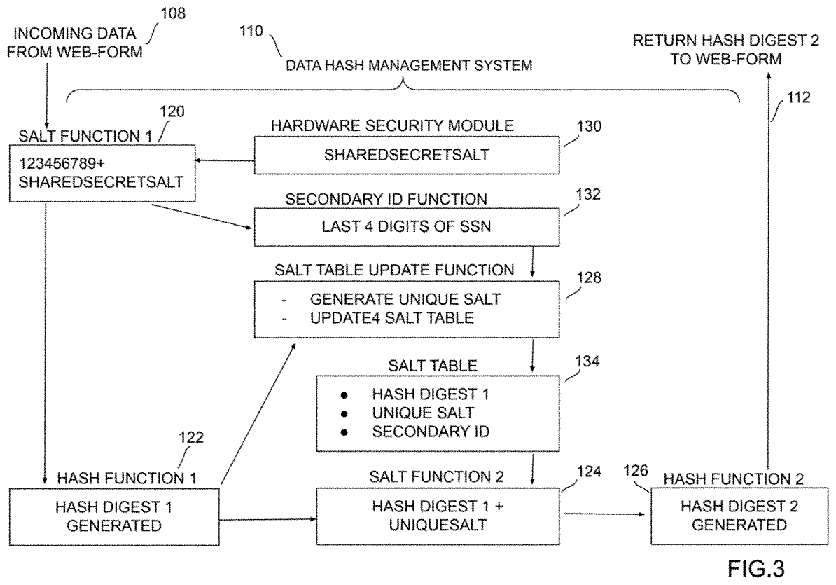

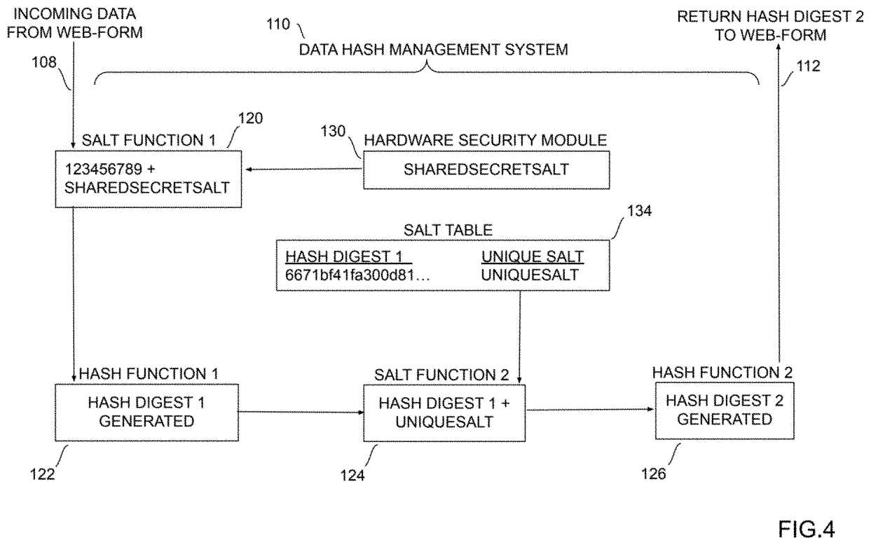

Data Hash Management System 110 includes computing hardware such as a server, memory, databases, Hardware Security Module, and programmed instructions to execute random salt generation, data hashing, database updating and lookup processes which are further detailed in FIG. 2, FIG. 3 and FIG. 4.

FIG. 2 is a simplified block diagram depicting the multiple step salting and hashing processes programmed to run on the Data Hash Management System 110. The Data Collector's web-form initiates an Application Programming Interface call via secure encrypted data transmission tunnel such as a VPN 108 to the Data Hash Management System. The Data Hash Management System 110 is programmed to receive the incoming plaintext social security number entered by the Data Owner via the Data Collector web-form 100.

Upon receipt of the plaintext input the Data Hash Management System 110 runs Salt Function 1 120 which appends a Shared Secret Salt value to the plaintext social security number input. The Shared Secret Salt is used for all incoming hashing requests in the first of two hashing steps. The combined plaintext social security number and Shared Secret Salt value is passed to Hash Function 1 122 which performs the one-way hashing operation on the salted plaintext social security number and generates Hash Digest 1. In the exemplified embodiment, SHA-256 hashing function is used, however any hashing function can be applied.

Next, Salt Function 2 124 generates and appends a Unique Salt value to Hash Digest-1 and passes the combined Hash Digest 1 and Unique Salt to the next programmed step, Hash Function 2 126. Hash Function 2 performs a hashing operation on the salted Hash Digest 1 and generates Hash Digest 2. Hash Digest 2 is the fully transformed substitute for the original plaintext social security number. Hash Digest 2 is transmitted over the encrypted data transmission tunnel or other secure connection 112 to the Data Collector's web-form Input Processing Function 114, then saved to the Data CollectoR Customer Database 118 over Data Collector's internal network connection 116. Additional detailed steps of this embodiment are outlined in subsequent FIG. 3 and FIG. 4.

FIG. 3 is a simplified block diagram depicting the systems and methods that comprise the Data Hash Management System 110 and the processes related to initial setup of a new customer or user in the system. In order for a Data Collector to participate in the Data Hash Management System, they must pre-register to verify their identity and be approved by the Hash Manager. Data Collectors must authenticate to the Data Hash Management System to gain access.

As part of the initial setup of the Data Hash Management System a Shared Secret Salt value is generated and saved in the Hardware Security Module. This Shared Secret Salt is prepended or appended to every plaintext social security number transmitted from Data Collector web-forms as part of the first of two salting and hashing processes. Upon receiving an Application Programming Interface call over encrypted data transmission tunnel such as a VPN 108 from the Data Collector web-form, Data Hash Management System 110 runs the programmed Salt Function 1 120 that retrieves the Shared Secret Salt value from the Hardware Security Module 130 and prepends or appends it to the plaintext social security number. Salt Function 1 120 passes the combined plaintext social security number and Secret Salt value to the Hash Function 1 122.

Hash Function 1 122 performs the hashing operation on the salted social security number which generates Hash Digest 1. Hash Function 1 122 initiates a program call to the Salt Table Update Function 128 to generate a Unique Salt value which the function assigns to Hash Digest 1. The Salt Table Update Function 128 records the Hash Digest 1 and the assigned Unique Salt pair into the Salt Table 134.

Salt Function 2 124 locates and appends the assigned Unique Salt value for Hash Digest 1 and passes the combined value on to Hash Function 2 126 which performs the hashing operation on the combined Hash Digest 1 and Unique Salt to generate Hash Digest 2. Hash Digest 2 represents the final transformed hash substitute for the plaintext social security number. Hash Digest is returned to the Data Collector web-form process over an encrypted data transmission tunnel or similarly secure connection 112.

The Data Hash Management System also runs the Secondary ID Function 132 which captures the last four digits of the social security number as a means to distinguish Data Owners in the event of a hash collision occurring. A hash collision is where two different inputs generate the same output. It is not known to have occurred with any hashing algorithm versions later than SHA-1. Secondary ID Function 132 can be programmed to capture alternate identifying data elements such as full or partial names, dates of birth, etc. Secondary ID Function 132 records the captured value to the Salt Table 134.

FIG. 4 is a simplified block diagram depicting an existing customer lookup process running in the Data Hash Management System 110. The process flow is similar to that described in FIG. 3, however the Unique Salt value assignment and Salt Table Update steps do not apply for a returning customer whose presence is already established in the Data Hash Management System 110.

Upon receiving the plaintext social security number input transmitted from the Data Collector's web-form over an encrypted data transmission tunnel or other secure connection 108, Salt Function 1 120 appends the Shared Secret Salt value to the plaintext social security number and passes the salted social security number to Hash Function 1 122.

Hash Function 1 performs the hashing operation on the salted social security number and generates Hash Digest 1 which is then passed to Salt Function 2 124. Salt Function 2 124 locates Hash Digest 1 in the Salt Table 134 and appends its Unique Salt value to Hash Digest 1 and passes the combined value to Hash Function 2 126.

Hash Function 2 126 performs the hashing operation on the combined Hash Digest 1 and Unique Salt to generate Hash Digest 2. Hash Digest 2 represents the final transformed hash substitute for the plaintext social security number. Hash Digest is returned to the Data Collector web-form process over an encrypted data transmission tunnel or other secure connection 112.

For purposes of illustration, an example embodiment in the context of collecting social security numbers has been described here. However the process is equally applicable in scenarios involving collection of other sensitive data, the loss of which to bad actors can result in considerable harm to the Data Owner. For example, the described method using one-way hashing can facilitate the collection, storage and subsequent presentation of credit card or bank account numbers to settle payment for goods and services, or for recurring charges for subscription fees.

What is claimed:

1. A system and methods for transforming personally identifiable information using a one-way hash function to securely collect, store and utilize sensitive data to confirm individual identity comprising:
a computer system having secure external connectivity and a programming interface to receive input data from, and transmit processed data back to an external entity;
a dedicated network security appliance for secure storage of secret cryptographic salt;
computer implemented processes configured to perform hashing operations, generate random character strings, establish secure connections and perform multiple coordinated serial operations.

2. The system of claim 1, wherein secure external connectivity is an encrypted data transmission tunnel employing AES-128, AES-192, AES-256 or any successor encryption standard.

3. The system of claim 1, wherein external entities are pre-vetted, approved and registered authorized users of the system.

4. The system of claim 1, wherein computer program application programming interface is configured to authenticate explicitly authorized external users and entities to access the system.

5. The system of claim 1, wherein a dedicated network appliance is a hardware security module, a standalone computing device or plug-in network card, dedicated cryptographic processing device configured for secure salt generation and secret salt storage.

6. A computer implemented method for transforming plaintext inputs of sensitive personal information, replacing said sensitive personal information with a transformed hash digest, the method comprising:
executing a programmed function to append a secret salt value to the initiating plaintext input incoming from an external source;
executing a programmed function to perform an initial hashing operation on the incoming plaintext and appended secret salt value;
executing a programmed function to capture from the plaintext input a portion of the original plaintext to serve as an alternate verification data point;
executing a programmed function to generate and assign a unique salt value to an initial hash digest, and update the salt table;
executing a programmed function to perform a secondary salting function; and
executing a programmed function to perform a secondary hashing operation.

7. A computer implemented method of claim 6, wherein the secret salt value is stored in a hardware security module to provide a high level of data security through explicit permission-based access rules, capable of detecting physical and logical tampering attempts, and having programmed reactive mechanisms to prevent the loss of sensitive data.

8. A computer implemented method of claim 6, wherein the salting function's application programming interface receives the incoming plaintext input from the external source over the established encrypted data transmission tunnel, holding it in temporary memory, then interfacing with the hardware security module to obtain the stored secret salt value to append said secret salt to the plaintext input, then passing the combined plaintext and secret salt to the initial hashing function.

9. A computer implemented method of claim 6, wherein the initial hashing function performs a hashing operation on the plaintext input with the appended secret salt to generate the initial hash digest, passing said hash digest to two separate downstream processes, the processes being a salt table update function and a secondary salt function.

10. A computer implemented method of claim 9, wherein the salt table update function is programmed to generate a unique salt value and assign it to the initial hash digest, recording the initial hash digest and its paired unique salt value to a salt table saved in an internal database, salt table being a directory of initial hash digests and their assigned unique salts. Where the hash digest and unique salt pair already exist in the salt table, the user presence on the system having previously been established, the salt table update function does not execute.

11. A computer implemented method of claim 9, wherein the secondary salt function is programmed to receive the initial hash digest passed from the initial hashing function, look up the initial hash digest in the salt table to ascertain its paired unique salt value, append said unique salt value to the initial hash digest, passing the combined value to the secondary hashing function.

12. A computer implemented method of claim 6, wherein the secondary hashing function receives the combined initial hash digest and unique salt passed to it from the secondary salt function, performs a hashing operation on the combined value to generate the secondary hash digest, the secondary hash digest being the final product in the plaintext input transformation process, and transmitted back to the data collector's web-form over the established encrypted data transmission tunnel.
